(19) United States
(12) Patent Application Publication
(10) Pub. No.: US 2006/0165946 A1
(43) Pub. Date: Jul. 27, 2006

(54) Optical storage medium

(75) Inventor: Hiroshi Tabata, Mito-Shi (JP)

Correspondence Address: RENNER, KENNER, GREIVE, BOBAK,;TAYLOR & WEBER, First National Tower, Fourth Floor, Akron, OH, 44308-1456, US

(73) Assignee: Victor Company of Japan, Ltd.

(21) Appl. No.: 11/338,508

(22) Filed: Jan. 24, 2006

(30) Foreign Application Priority Data
Jan. 26, 2005 (JP) 2005-17894

(51) Int. Cl. B32B 3/02

(52) U.S. Cl. 428/64.4

(57) ABSTRACT

A phase-change optical storage medium includes a recording layer that has an alloy of Ge—Sb—In—Sn, as a main component in the materials that constitute the recording layer. Composition ratios of Ge, Sb, In and Sn in the alloy satisfy ranges 0.08≦a≦0.20, 0.60≦b≦0.80, 0.05≦c≦0.20, and 0.01≦d≦0.15, where “a”, “b”, “c” and “d” are the composition ratios of Ge, Sb, In and Sn, respectively, at a +b+c+d=1. A percentage of the alloy in the materials that constitute the recording layer may be 50% or higher.

### CROSS-REFERENCE TO RELATED APPLICATIONS

This application is based on and claims the benefit of priority from the prior Japanese Patent Application No. 2005-017894 filed on Jan. 26, 2005, the entire content of which is incorporated herein by reference.

### BACKGROUND OF THE INVENTION

The present invention relates to an optical storage medium in or from which data is recorded, erased or reproduced with irradiation of a light beam (for example, a laser beam).

A phase-change optical storage medium, such as an optical disc and an optical card, is one type of optical storage media, that is a data-rewritable storage medium. Recent CD-RW, DVD-RW and DVD-RAM are a phase-change optical storage medium. Especially, DVD-RW and DVD-RAM are used for recording and rewriting a large amount of data, such as, video data. What are required for phase-change optical storage media are recordability at high linear velocity in addition to excellent recording and overwrite characteristics.

Discussed below are a known rewritable phase-change optical storage medium and a recording method for such a storage medium.

A known phase-change optical storage medium has a structure in which at least a dielectric layer, a recording layer, another dielectric layer and a reflective layer are stacked in order on a substrate having a bottom surface to be irradiated with a laser beam carrying a recording or reproducing power, or an erasing power.

In recording, recording pulses are applied (emitted) onto a recording layer with a laser beam having a specific recording power, to melt and rapidly cool down the recording layer, thus forming amorphous recorded marks thereon.

Reflectivity of the recorded marks lower than that of a crystalline-phase recording layer allows optical reading of the marks as recorded data.

In erasing the recorded marks, a laser beam having a power (erasing power) lower than the recording power is emitted onto the recording layer. The laser beam raises the temperature thereof to the crystallization temperature or higher but lower than the melting point to change the recording layer from the amorphous phase to the crystalline phase to erase the recorded marks, thus overwriting being enabled.

Japanese Patent No. 3150267 discloses an optical storage medium having a recording layer made of an alloy of 5 elements Ge (or Si)—Ag—In—Sb—Te. This alloy is made by adding Ge or Si to an alloy of 4 elements Ag—In—Sb—Te.

A known technique to achieve high-linear velocity recording with this recording layer is to increase the amount of Sb but decrease the amount of Te in the recording layer made as above. This technique offers excellent recording characteristics over a wide range from lower-to intermediate-linear velocity recording, for example, from DVD×1 speed to DVD×4 speed at 14.0 m/s in linear velocity.

Ultra-high speed recording at rewritable DVD×6 speed or higher, however, requires a larger amount of Sb to achieve a higher crystallization speed for the recording layer made as above.

Confirmed by the inventor of the present invention in ultra-high speed, recording with a larger amount of Sb are: poor storagability due to decrease in crystallization temperature of the recording layer, and poor rewritability due to increase in noise in reproduced signals. Also confirmed for the recording layer initialized with a bulk laser is a higher jitter level in the initial rewriting caused by a higher peak-to-peak level of reproduced signals (observed with an oscilloscope) from an un-recorded region in the recording layer with a laser beam in reproduction, due to different reflectivity levels in the several components of the recording layer, discussed above, in a crystalline phase.

Japanese Unexamined Patent Publication Nos. 2001-039031 and 2002-347341 disclose optical storage media having a recording layer, the main elements in the composition of which are Ge, In and Sb.

Confirmed by the inventor of the present invention in ultra-high speed recording at DVD×6 speed and higher for these optical storage media are: excellent recording characteristics and also excellent overwrite recording characteristics in the initial overwriting, whereas unacceptable overwrite recording characteristics in around 1000th overwriting or more, due to adverse jitter levels.

As discussed above, the known phase-change optical storage medium having the recording layer including a chalcogen, such as, Te suffers unacceptable recording characteristics in high-linear velocity recording at DVD×6 speed or higher. The other known phase-change optical storage media having the recording layer without such a chalcogen exhibit excellent recording characteristics, but, still unacceptable overwrite characteristics in high-linear velocity recording.

### SUMMARY OF THE INVENTION

The present invention is achieved to solve the problems discussed above and has a purpose to provide an optical recording storage medium that exhibits excellent recording characteristics in high-linear velocity recording (for example, at DVD×6 speed or higher) and excellent overwrite characteristics in initial or a plural number of overwriting, and also excellent storagability.

The present invention provides a phase-change optical storage medium comprising a recording layer including an alloy of Ge—Sb—In—Sn, as a main component in materials that constitute the recording layer, composition ratios of Ge, Sb, In and Sn in the alloy satisfying ranges 0.08≦a≦0.20, 0.60≦b≦0.80, 0.05≦c≦0. 20, and 0.01≦d≦0.15, where “a”, “b”, “c” and “d” are the composition ratios of Ge, Sb, In and Sn, respectively, at a+b+c+d=1.

### BRIEF DESCRIPTION OF DRAWINGS

FIG. 1 is an enlarged cross section illustrating an embodiment of an optical storage medium according to the present invention;

FIG. 2 is a view illustrating an example of a recording pulse pattern;

FIG. 3 is a table listing initial and overwrite recording characteristics for several embodiment and comparative sample optical storage media according to the present invention; and

FIG. 4 is an enlarged cross section illustrating another embodiment of an optical storage medium according to the present invention.

### DETAILED DESCRIPTION OF PREFERRED EMBODIMENTS

Preferred embodiments of an optical storage medium according to the present invention will be disclosed.

[Structure of Optical Storage Medium]

Representative of phase-change optical storage media are phase-change optical discs such as DVD-RW, optical cards, and so on, capable of repeatedly overwriting data. A phase-change optical disc (an optical storage medium A) is described in the following description as an embodiment of the present invention. It will, however, be appreciated that the present invention is applicable to other types of phase-change optical storage media such as optical cards.

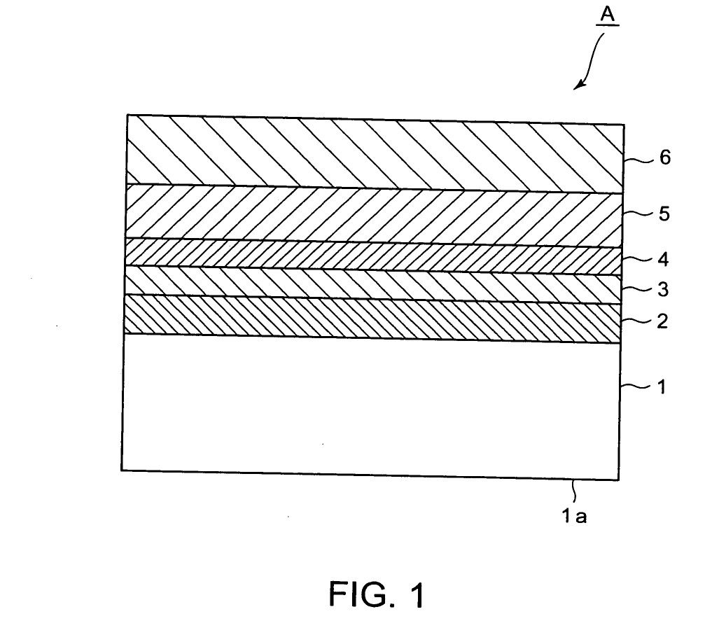

The optical storage medium A shown in FIG. 1 is an embodiment of the present invention. The figure is not drawn in scale and exaggerated particularly in the thickness direction for easier understanding.

The optical storage medium A has a structure in which a first protective layer 2, a recording layer 3, a second protective layer 4, a reflective layer 5, and a third protective layer 6 are stacked in order on a substrate 1 having a beam incident surface la on the opposite side on which a laser beam is incident in recording, reproducing or erasure.

Suitable materials for the substrate 1 are several types of transparent synthetic resins, a transparent glass, and so on. The transparent substrate 1 is used for protection against dust, damage, etc. A focused laser beam reaches the recording layer 3 through the incident plane 1a of the substrate 1 in recording. Suitable materials for the substrate 1 in such use are, for example, glass, polycarbonate, polymethylmethacrylate, polyolefin resin, epoxy resin, or polyimide resin. The most suitable material is polycarbonate resin for low birefringence and hygroscopicity, and also easiness to mold.

Although not limited, in compatibility with DVD, the thicknesses of the substrate 1 is preferably in the range from 0.01 mm to 0.6 mm, particularly, 0.6 mm (for the total DVD thickness of 1.2 mm). This is because dust easily affects recording with a focused laser beam through the incident plane la of the substrate 1 when the thickness of the substrate 1 is less than 0.01 mm. A practical thickness for the substrate 1 is in the range from 0.01 mm to 5 mm if there is no particular requirement for the total thickness of the optical storage medium. The thickness over 5 mm causes difficulty in increase in objective-lens numerical aperture, which leads to larger laser spot size, hence resulting in difficulty in increase in storage density.

The substrate 1 may be flexible or rigid. A flexible substrate 1 is used for tape-, sheet- or card-type optical storage media whereas a rigid substrate 1 for card- or disc-type optical storage media.

The first and second protective layers 2 and 4 protect the substrate 1, the recording layer 3, etc., from thermal deformation in recording which could otherwise cause poor recording characteristics. In addition, the protective layers 2 and 4 enhance signal contrast in reproduction by optical interference.

The first and second protective layers 2 and 4 allow a laser beam to pass therethrough in recording, reproduction or erasure and exhibit a refractive index “n”, preferably, in the range of 1.9≦n≦2.3. A suitable material for the protective layers 2 and 4 is a material that exhibits high thermal resistance properties, for example, an oxide such as SiO₂, SiO, ZnO, TiO₂, Ta₂O₅, Nb₂O₅, ZrO₂ or MgO, a sulfide such as ZnS, In₂S₃ or TaS₄, or carbide such as SiC, TaC, WC or TiC, or a mixture of these materials. Among them, a mixture of ZnS and SiO₂ is the best for high recording sensitivity, C/N and erasing rate against repeated recording, reproduction or erasure.

The first and second protective layers 2 and 4 may or may not be made of the same material or composition.

The thickness of the first protective layer 2 is in the range from about 5 nm to 500 nm, preferably, 40 nm to 300 nm so that it cannot be easily peeled off from the substrate 1 or the recording layer 3 and is not prone to damage such as cracks. The thickness below 40 nm hardly offers high disc optical characteristics whereas over 300 nm causes lower productivity.

The thickness of the second protective layer 4 is, preferably, in the range from 0.5 nm to 50 nm for high recording characteristics such as C/N and erasing rate, and also high stability in a number of repeated overwriting. The thickness below 0.5 nm hardly gives enough heat to the recording layer 3, resulting in increase in optimum recording power, whereas over 50 nm causes poor overwrite characteristics.

The recording layer 3 is an alloy layer having a Ge—Sb—In—Sn alloy as a main component. Having the Ge—Sb—In—Sn alloy as a main component means a percentage of this alloy in the materials that constitute the recording layer 3 is 50% or higher, preferably, 90% or higher. A preferable thickness for the recording layer 3 is in the range from 10 nm to 25 nm. The thickness below 10 nm lowers the crystallization speed to cause poor high-speed recording characteristics whereas over 25 nm requires higher laser power in recording.

An interface layer may be provided on either or each surface of the recording layer 3. One requirement for the interface layer is that it is made of a material without sulfides. An interface layer made of a material including a sulfide causes diffusion of the sulfide into the recording layer 3 if overwriting is repeated, which could lead to poor recording characteristics, and also poor erasing characteristics.

An acceptable material for the interface layer includes at least any one of a nitride, an oxide and a carbide, specifically, germanium nitride, silicon nitride, aluminum nitride, aluminum oxide, zirconium oxide, chromium oxide, silicon carbide and carbon. Oxygen, nitrogen or hydrogen may be added to the material of the interface layer. The nitride, oxide and carbide listed above may not be stoichiometric compositions for such an interface layer. In other words, nitrogen, oxygen or carbon may be excessive or insufficient, which could offer high performance, such as high durability in that the interface layer is hardly peeled off.

Preferable materials for the reflective layer 5 is a metal exhibiting light reflectivity, such as Al, Au or Ag, an alloy of any of these metals as a main component with at least one type of metal or semiconductor, and a mixture of a metal, such as Al, Au or Ag, and a metal nitride, a metal oxide or a metal chalcogen of Al, Si, etc.

Most preferable among them is a metal, such as Al, Au or Ag, or an alloy of any of these metals as a main component, for high reflectivity and thermal conductivity. A typical alloy is made of Al and at least one of the following elements: Si, Mg, Cu, Pd, Ti, Cr, Hf, Ta, Nb, Mn, Zr, etc., or Au or Ag and at least one of the following elements: Cr, Ag, Cu, Pd, Pt, Ni, Nd, etc. For high linear velocity recording, the most preferable one is a metal or an alloy having Ag exhibiting extremely high thermal conductivity as a main component, in view of recording characteristics. Having Ag as a main component means Ag is the material or the element most involved among all of the materials or elements that constitute the reflective layer 5. The percentage of Ag in the materials or elements that constitute the reflective layer 5 is preferably 50% or higher, more preferably 95% or higher.

Any layer that touches the reflective layer 5 is preferably made of materials without S when the layer 5 is made of pure silver or a silver alloy, to restrict production of an AgS compound.

The thickness of the reflective layer 5 is preferably in the range from 50 nm to 300 nm, depending on thermal conductivity of its material. A thicker reflective layer 5 at 50 nm or more does not optically vary and hence stable in reflectivity but affects a cooling rate. Thickness over 300 nm requires a longer production time. A material exhibiting a high thermal conductivity allows the reflective layer 5 to have a thickness in an optimum range such as mentioned above.

A diffusion prevention layer (not shown) is, preferably, provided between the second protective layer 4 and the reflective layer 5 when the layer 4 is made of a compound of ZnS and SiO₂ and the layer 5 is made of Ag or an alloy of Ag, to restrict decrease in reflectivity due to generation of a compound of AgS because of chemical reaction between S of the layer 4 and Ag of the layer 5.

One requirement for the material of the diffusion prevention layer is that it is made of a material without sulfides, like the interface layer described above. Such materials for the diffusion prevention layer are the same as those for the interface layer, and also a metal, a semiconductor, silicon, and germanium chrome nitride.

[Optical Storage Medium Production Method]

Disclosed next is a method of producing the optical storage medium A shown in FIG. 1.

Lamination of the first protective layer 2, the recording layer 3, the second protective layer 4, the reflective layer 5, etc., on the substrate 1 is achieved by any known vacuum thin-film forming technique, such as, vacuum deposition (with resistive heating or electron bombardment), ion plating, (D.C., A.C. or reactive) sputtering. The most feasible among these techniques is sputtering for easiness of composition and film-thickness control.

A film-forming system feasible in this method is a batch system in which a plural number of substrates 1 are simultaneously subjected to a film forming process in a vacuum chamber or a single-wafer system in which substrates 1 are processed one by one. The thickness of the first protective layer 2, the recording layer 3, the second protective layer 4, the reflective layer 5, etc., can be adjusted with control of power to be supplied and its duration in sputtering or monitoring conditions of deposited layers with a crystal oscillator.

The first protective layer 2, the recording layer 3, the second protective layer 4, the reflective layer 5, etc., can be formed while each substrate 1 is being stationary, transferred or rotating. Rotation of the substrate (and further with orbital motion) is most feasible for higher uniformity of layer thickness. An optional cooling process minimizes warpage of the substrate 1.

A dielectric layer of ZnS, SiO₂, etc., or a resin protective layer made of, for example, an ultraviolet-cured resin may be provided as the third protective layer 6 according to necessity, after the reflective layer 5, etc., are formed, to protect those layers already formed against deformation, in the extent which does not make the present invention extremely less advantageous.

Two substrates 1 having the same layers may be prepared and bonded to each other, for example by an adhesive, as a double-sided optical storage medium.

Performed next is initialization of the optical storage medium A with irradiation of a laser beam or light of a xenon flash lamp onto the recording layer 3 so that the layer 3 is heated and thus crystallized. Initialization with a laser beam is a better choice for less noise in reproduction.

[Study of Material of Recording Layer]

The inventor of the present invention presupposed that excellent recording and overwrite characteristics could be given to the optical storage medium A with a specific atomic ratio for materials of the recording layer 3, and found out that the presumption is correct and there is an optimum atomic ratio based on the following embodiment samples 1 to 9 and comparative samples 1 to 12.

Each embodiment and comparative sample was subjected to recording (1-beam overwriting) and reproduction with a disc drive tester (DDU1000) equipped with a 660 nm-wavelength laser diode and an optical lens (NA=0.60) made by Pulstec. Co.

Reproduction was evaluated with an 8-16 (EFM+) modulation random sequence at linear velocity of 21 m/s (corresponding to DVD-RW specification 6×speed) for every sample and also 28 m/s (corresponding to DVD-RW specification 8×speed) for some samples. The unit clock T was 6.4 ns (corresponding to DVD 6×speed) or 4.8 ns (corresponding to DVD 8×speed). The bit length was 0.267 pm/bit. Recording was conducted in the same density as DVD-ROM, with the capacity corresponding to 4.7 gigabytes. Recording of 1-, 2-, 10-, and 1000-time overwriting were conducted to a target track and adjacent tracks, followed by slicing at the amplitude center of each reproduced signal for measurements of clock to data jitters with the reproduction-dedicated equipment LM220A made by Shibasoku Co., Ltd., at 7.0 m/s in linear velocity. The reproducing power Pr was constant at 0.4 mW. Qantitative analysis for the recording layer was conducted with a fluorescent X-ray analyzer SRS303 made by Siemens AG.

### Embodiment Sample 1

As discussed below, several layers were formed on the substrate 1 made of a polycarbonate resin with 120 mm in diameter and 0.6 mm in thickness. Grooves were formed on the substrate 1 at 0.74 μm in track pitch, with 25 nm in groove depth and about 40:60 in width ratio of groove to land. The grooves were formed as convex section when viewed from the beam incident surface la shown in FIG. 1.

After a vacuum chamber was exhausted up to 3×10⁻⁴ Pa, a 66 nm-thick first protective layer 2 was formed on the substrate 1 by high-frequency magnetron sputtering with a target of ZnS added with 20-mol % SiO₂ at 2×10⁻¹ Pa in Ar-gas atmosphere.

Formed on the first protective layer 2, in order, were a 16 nm-thick recording layer 3 by co-sputtering with targets of an alloy of 3 elements Ge—Sb—In and also of an alloy of a single element of Sn at a composition ratio of Gel₂5b₇₀In₁₃Sn₅, a 16nm-thick second protective layer 4 of the same material as the first protective layer 2, and a 120 nm-thick reflective layer 5 with a target of Ag—Pd—Cu.

The substrate 1 was taken out from the vacuum chamber. The reflective layer 5 was spin-coated with an acrylic UV-curable resin (SK5110 made by Sony Chemicals. Co.). The resin was cured with radiation of UV rays so that a 3 μm-thick third protective layer 6 was formed on the layer 5.

Accordingly, the optical storage medium A of the embodiment sample 1 such as shown in FIG. 1 was produced.

The optical storage medium A produced as above was exposed to a laser beam having a width in a tracking direction wider than that in a radius direction on the medium A. The recording layer 3 was heated to the crystallization temperature or higher to be initialized.

Then, recording was conducted to the grooves of the recording layer 3 on the substrate 1 side.

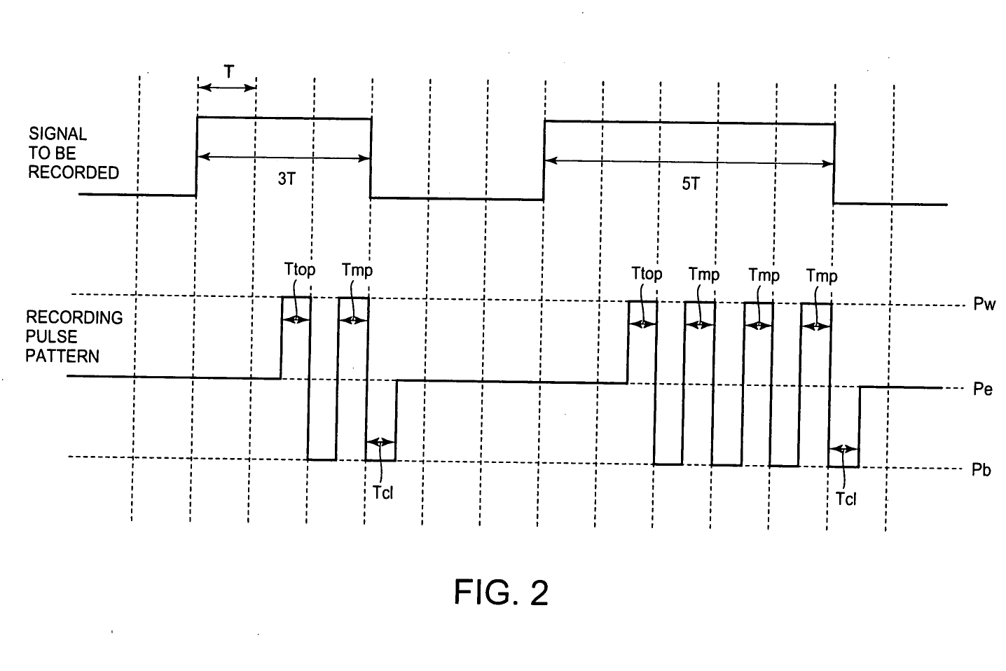

FIG. 2 illustrates a recording pulse pattern used in recording. A laser beam was modulated with laser intensity at three levels (a recording power Pw, an erasing power Pe and a bottom power Pb) based on the recording pulse pattern, with increase or decrease in the number of pulses in accordance with a mark length carried by a signal to be recorded, to form recorded marks having a given mark length on the recording layer 3. In terms of laser intensity, the recording power Pw was the largest, the erasing power Pe the smaller, and the bottom power Pb the smallest.

As illustrated in FIG. 2, the recording pulse pattern consists of a top pulse Ttop that rises from the erasing power Pe for initially applying a laser beam onto the recording layer 3 with the recording power Pw, multipulses Tmp, that follows the top pulse Ttop, for alternatively applying the recording power Pw and the bottom power Pb, and an erasing pulse Tcl, located at the end of the pattern, that rises from the bottom power Pb in application of a laser beam with the erasing power Pe. The top pulse Ttop and the multipulses Tmp constitute a recording pulse for recording a recorded mark on the recording layer 3. A recording pulse may be formed only with the top pulse Ttop with no multipulses Tmp.

In 6×speed recording, overwriting was conducted to a target track and adjacent tracks at a recording power Pw of 23 mW, an erasing power Pe of 6 mW, and a bottom power Pb of 0.5 mW.

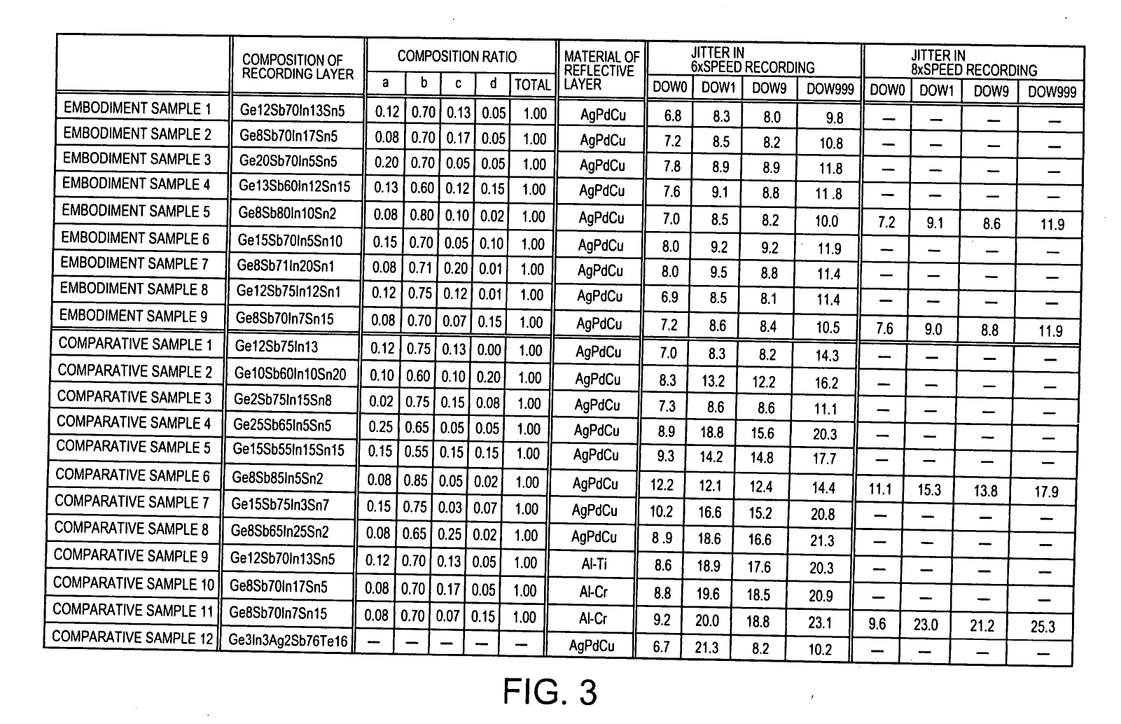

The measured initial and overwrite recording characteristics are shown in FIG. 3 for the embodiment samples 1 to 9 and also the comparative samples 1 to 12, with irregular but easy-seeing expressions for the composition of the recording layer 3, such as, Ge12Sb70In13Sn5 that is usually expressed as Ge₁₂Sb₇₀In₁₃Sn₅.

Several composition ratios are listed in FIG. 3 for the embodiment samples 1 to 9 and the comparative samples 1 to 12, at a+b+c+d=1 when each composition of the recording layer 3 is expressed as GeₐSb_{b}In_{c}Sn_{d}.

As shown in FIG. 3, the embodiment sample 1 exhibited: 6.8% in initial-recording (DOWO) jitter, 8.3% in lst-overwrite (DOW1) jitter, 8.0% in 9th-overwrite (DOW9) jitter, an0d 9.8% in 999th-overwrite (DOW999) jitter, with excellent recording characteristics as well as stable overwrite characteristics.

In the disclosure, overwriting is 1-beam overwriting for erasing a recorded mark already formed and forming a new recorded mark with one-time laser scanning. Also defined in the disclosure are: DOW0; initial recording for forming a recorded mark on an un-recorded section of an initialized optical storage medium A; and DOW11st overwriting for forming another recorded mark on the initially recorded section. Defined further in the disclosure are: “excellent” in jitter of 12% or less and “unacceptable” in jitter over 12% that is a critical level, beyond which could give adverse effects to the error rate.

### Embodiment Sample 2

Measurements were made for an embodiment sample optical storage medium A produced in the same way as the embodiment sample 1, except for change in the composition of the recording layer 3 to Ge₈Sb₇₀In₁₇Sn₅.

As shown in FIG. 3, the embodiment sample 2 exhibited: 7.2% in DOW0 jitter, 8.5% in DOW1 jitter, 8.2% in DOW9 jitter, and 10.8% in DOW999 jitter, with excellent recording characteristics as well as stable overwrite characteristics.

### Embodiment Sample 3

Measurements were made for an embodiment sample optical storage medium A produced in the same way as the embodiment sample 1, except for change in the composition of the recording layer 3 to Ge₂₀Sb₇₀In₅Sn₅.

As shown in FIG. 3, the embodiment sample 3 exhibited: 7.8% in DOW0 jitter, 8.9% in DOW1 jitter, 8.9% in DOW9 jitter, and 11.8% in DOW999 jitter, with excellent recording characteristics as well as stable overwrite characteristics.

### Embodiment Sample 4

Measurements were made for an embodiment sample optical storage medium A produced in the same way as the embodiment sample 1, except for change in the composition of the recording layer 3 to Ge₁₃Sb₆₀In₁₂Sn₁₅.

As shown in FIG. 3, the embodiment sample 4 exhibited: 7.6% in DOW0 jitter, 9.1% in DOW1 jitter, 8.8% in DOW9 jitter, and 11.8% in DOW999 jitter, with excellent recording characteristics as well as stable overwrite characteristics.

### Embodiment Sample 5

Measurements were made for an embodiment sample optical storage medium A produced in the same way as the embodiment sample 1, except for change in the composition of the recording layer 3 to Ge₈Sb₈₀In₁₀Sn₂.

As shown in FIG. 3, the embodiment sample 5 exhibited: 7.0% in DOW0 jitter, 8.5% in DOW1 jitter, 8.2% in DOW9 jitter, and 10.0% in DOW999 jitter, with excellent recording characteristics as well as stable overwrite characteristics.

Further measurements made for the embodiment sample 5 were initial and overwrite recording characteristics at a recording linear velocity of 28 m/s (corresponding to 8×speed in DVD-RW specifications) at a recording power Pw of 28 mW, an erasing power Pe of 7 mW, and a bottom power Pb of 0.5 mW.

In 8×speed recording, the embodiment sample 5 exhibited: 7.2% in. DOW0 jitter, 9.1% in DOW1 jitter, 8.6% in DOW9 jitter, and 11.9% in DOW999 jitter, with excellent recording characteristics as well as stable overwrite characteristics.

### Embodiment Sample 6

Measurements were made for an embodiment sample optical storage medium A produced in the same way as the embodiment sample 1, except for change in the composition of the recording layer 3 to Ge₁₅Sb₇₀In₅Sn₁₀.

As shown in FIG. 3, the embodiment sample 6 exhibited: 8.0% in DOW0 jitter, 9.2% in DOW1 jitter, 9.2% in DOW9 jitter, and 11.9% in DOW999 jitter, with excellent recording characteristics as well as stable overwrite characteristics.

### Embodiment Sample 7

Measurements were made for an embodiment sample optical storage medium A produced in the same way as the embodiment sample 1, except for change in the composition of the recording layer 3 to Ge₈Sb₇₁In₂₀Sn₁₅.

As shown in FIG. 3, the embodiment sample 7 exhibited: 8.0% in DOW0 jitter, 9.5% in DOW1 jitter, 8.8% in DOW9 jitter, and 11.4% in DOW999 jitter, with excellent recording characteristics as well as stable overwrite characteristics.

### Embodiment Sample 8

Measurements were made for an embodiment sample optical storage medium A produced in the same way as the embodiment sample 1, except for change in the composition of the recording layer 3 to Ge₁₂Sb₇₅In₁₂Sn₁₀.

As shown in FIG. 3, the embodiment sample 8 exhibited: 6.9% in DOW0 jitter, 8.5% in DOW1 jitter, 8.1% in DOW9 jitter, and 11.4% in DOW999 jitter, with excellent recording characteristics as well as stable overwrite characteristics.

### Embodiment Sample 9

Measurements were made for an embodiment sample optical storage medium A produced in the same way as the embodiment sample 1, except for change in the composition of the recording layer 3 to Ge₈Sb₇₀In₇Sn₁₅.

As shown in FIG. 3, the embodiment sample 9 exhibited: 7.2% in DOW0 jitter, 8.6% in DOW1 jitter, 8.4% in DOW9 jitter, and 10.5% in DOW999 jitter, with excellent recording characteristics as well as stable overwrite characteristics.

Further measurements were made for the embodiment sample 9 in 8×speed recording under the same requirements as the embodiment sample 5.

In 8×speed recording, the embodiment sample 9 exhibited: 7.6% in DOW0 jitter, 9.0% in DOW1 jitter, 8.8% in DOW9 jitter, and 11.9% in DOW999 jitter, with excellent recording characteristics as well as stable overwrite characteristics.

A test on storage characteristics was also conducted for the embodiment samples 1 to 9 at a temperature of 80° C. and a relative humidity of 85% (80° C.85%RH) for 96 hours. Results were excellent in recording characteristics on jitters, reflectivity, etc., for every embodiment sample.

### Comparative Sample 1

Measurements were made for a comparative sample optical storage medium A produced in the same way as the embodiment sample 1, except for change in the composition of the recording layer 3 to Ge₁₂Sb₇₅In₁₃.

As shown in FIG. 3, the comparative sample 1 exhibited unacceptable jitter of 14.3% in DOW999. A possible reason for this adverse level was segregation in the recording layer 3 due to overwriting.

The same measurements for another comparative sample with the composition different from Ge₁₂Sb₇₅In₁₃ (the comparative sample 1) for the recording layer 3 showed unacceptable overwrite characteristics.

It was found through the measurements that any composition without Sn for the recording layer 3 gives unacceptable overwrite characteristics, under the present invention.

### Comparative Sample 2

Measurements were made for a comparative sample optical storage medium A produced in the same way as the embodiment sample 1, except for change in the composition of the recording layer 3 to Ge₁₀Sb₆₀In₁₀Sn₂₀.

As shown in FIG. 3, the comparative sample 2 exhibited unacceptable jitters of 13.2%, 12.2% and 16.2% in DOW1, DOW9 and DOW999, respectively. A possible reason for these adverse levels was increase in noises in the reproduced signals due to increase in the composition ratio of Sn to 20%.

### Comparative Sample 3

Measurements were made for a comparative sample optical storage medium A produced in the same way as the embodiment sample 1, except for change in the composition of the recording layer 3 to Ge₂Sb₇₅In₁₅Sn₈.

As shown in FIG. 3, the comparative sample 3 exhibited excellent recording characteristics on jitters from DOW0 to DOW999. Nevertheless, the test on storage characteristics discussed above resulted in erasure of recorded marks, thus unacceptable storage characteristics. A possible reason was instability in recorded marks due to insufficient amount of Ge.

### Comparative Sample 4

Measurements were made for a comparative sample optical storage medium A produced in the same way as the embodiment sample 1, except for change in the composition of the recording layer 3 to Ge₂₅Sb₆₅In₅Sn₅.

As shown in FIG. 3, the comparative sample 4 exhibited unacceptable jitters of 18.8%, 15.6% and 20.3% in DOW1, DOW9 and DOW999, respectively. A possible reason was increase in noises in the reproduced signals due to excess amount of Ge.

### Comparative Sample 5

Measurements were made for a comparative sample optical storage medium A produced in the same way as the embodiment sample 1, except for change in the composition of the recording layer 3 to Ge₁₅Sb₅₅In₁₅Sn₁₅.

As shown in FIG. 3, the comparative sample 5 exhibited unacceptable jitters of 14.2%, 14.8% and 17.7% in DOW1, DOW9 and DOW999, respectively. A possible reason was a crystallization speed not enough for 6×speed due to insufficient amount of Sb.

### Comparative Sample 6

Measurements were made for a comparative sample optical storage medium A produced in the same way as the embodiment sample 1, except for change in the composition of the recording layer 3 to Ge₈Sb₈₅In₅Sn₂.

As shown in FIG. 3, the comparative sample 5 exhibited unacceptable jitters from DOW0 to DOW999.

Further measurements were made for the comparative sample 6 in 8×speed recording under the same requirements as the embodiment sample 5.

In 8×speed recording, the comparative sample 6 exhibited unacceptable recording characteristics on jitters from DOW1 to DOW999.

A possible reason for the unacceptable recording characteristics in 6×and 8×speed recording was increase in noise components caused by increase in the area of minute Sb monocrystals with excess amount of Sb in the recording layer 3.

### Comparative Sample 7

Measurements were made for a comparative sample optical storage medium A produced in the same way as the embodiment sample 1, except for change in the composition of the recording layer 3 to Ge₁₅Sb₇₅In₃Sn₇.

As shown in FIG. 3, the comparative sample 7 exhibited unacceptable jitters of 16.6%, 15.2% and 20.8% in DOW1, DOW9 and DOW999, respectively, due to increase in noises in the reproduced signals caused by shortage of In.

### Comparative Sample 8

Measurements were made for a comparative sample optical storage medium A produced in the same way as the embodiment sample 1, except for change in the composition of the recording layer 3 to Ge₈Sb₆₅In₂₅Sn₂.

As shown in FIG. 3, the comparative sample 8 exhibited unacceptable jitter of 18.6%, 16.6% and 21.3% in DOW1, DOW9 and DOW999, respectively, due to increase in noises in the reproduced signals caused by excess amount of In.

### Comparative Sample 9

Measurements were made for a comparative sample optical storage medium A produced in the same way as the embodiment sample 1, except for change in material of the reflective layer 5 to AlTi.

As shown in FIG. 3, the comparative sample 8 exhibited unacceptable jitters of 18.9%, 17.6% and 20.3% in DOW1, DOW9 and DOW999, respectively.

### Comparative Sample 10

Measurements were made for a comparative sample optical storage medium A produced in the same way as the embodiment sample 2, except for change in material of the reflective layer 5 to AlCr.

As shown in FIG. 3, the comparative sample 10 exhibited unacceptable jitters in DOW1, DOW9 and DOW999.

### Comparative Sample 11

Measurements were made for a comparative sample optical storage medium A produced in the same way as the embodiment sample 9, except for change in material of the reflective layer 5 to AlCr.

As shown in FIG. 3, the comparative sample 11 exhibited unacceptable jitters in DOW1, DOW9 and DOW999.

Further measurements were made for the comparative sample 11 in 8×speed recording under the same requirements as the embodiment sample 5.

Also, in 8×speed recording, the comparative sample 11 exhibited unacceptable recording characteristics on jitters from DOW1 to DOW999.

### Comparative Sample 12

Measurements were made for a comparative sample optical storage medium A produced in the same way as the embodiment sample 1, except for change in composition of the recording layer 3 to Ge₃In₃Ag₂Sb₇₆Te₁₆ and in material of the reflective layer 5 to AgPdCu.

As shown in FIG. 3, the comparative sample 12 exhibited an unacceptable jitter of 21.3% in DOW1. A possible reason was increase in noises in the reproduced signals due to excess amount of Sb for increase in crystallization speed in the main component Sb₇₆Te₁₆ similar to an eutectic crystal Sb₇₀Te₃₀.

Through the measurements discussed above, it was found that the following ranges in composition ratio for the elements of an alloy of 4 elements Ge—Sb—In—Sn for the recording layer 3 offer excellent recording and overwrite characteristics:
0.08≦a≦0.20 (1)
0.60≦b≦0.80 (2)
0.05≦c≦0.20 (3)
0.01≦d≦0.15 (4)
where “a”, “b”, “c” and “d” are composition ratios of Ge, Sb, In and Sn, respectively, at a+b+c+d=1.

Among the 4 elements, Ge is the element required for excellent storage characteristics. The expression (1) shows a preferable range for the composition ratio “a” of Ge. The ratio “a” lower than 0.08 degrades storage stability for recorded marks whereas higher than 0.20 increases noises in the reproduced signals.

The expression (2) shows a preferable range for the composition ratio “b” of Sb. The ratio “b” lower than 0.60 causes lower crystallization speed, thus not match higher linear velocity recording whereas higher than 0.80 increases noises in the reproduced signals.

The expression (3) shows a preferable range for the composition ratio “c” of In. The ratio “c” lower than 0.05 increases noises in the reproduced signals, particularly, in DOW999 jitter, likewise, higher than 0.20 increases noises in the reproduced signals, in DOW1, DOW9 and DOW999 jitters.

The element Sn is required for excellent overwrite characteristics. The expression (4) shows a preferable range for the composition ratio “d” of Sn. The ratio “d” lower than 0.01 causes segregation in the recording layer 3 due to overwriting, thus resulting in unacceptable overwrite characteristics whereas higher than 0.15 increases noises in the reproduced signals. A more preferable range for the composition ratio “d” is 0.03≦d≦0.10, for excellent DOW jitter characteristics.

Also found through the measurements discussed above is as follows:

A material for the reflective layer 5 having Ag as a main component, that exhibits high thermal conductivity, offers excellent recording and overwrite characteristics when an alloy of 4 elements Ge—Sb—In—Sn is used for the recording layer 3.

In contrast, like the comparative samples 9 to 11, a material for the reflective layer 5 having Al as a main component (such as AlTi and AlCr) causes high jitter levels in DOW1 and the following overwriting.

A possible reason for such high jitter levels is that Al that exhibits thermal conductivity of 2.37 (W/cm·K) lower than that of 4.29 (W/cm·K) for Ag gives an optical disc a slow cooling mechanism so that a recording layer is easily turned into a crystalline phase or an erased state, thus causing inaccuracy of the size of recorded marks.

The present invention is applicable not only to phase-change optical storage media, like, DVD-RW, discussed above, but also to double-sided phase-change optical storage media having two phase-change optical storage media A with the substrates 1 being bonded to each other by an adhesive seal, and also to phase-change optical storage media having two or more of recording layers 3.

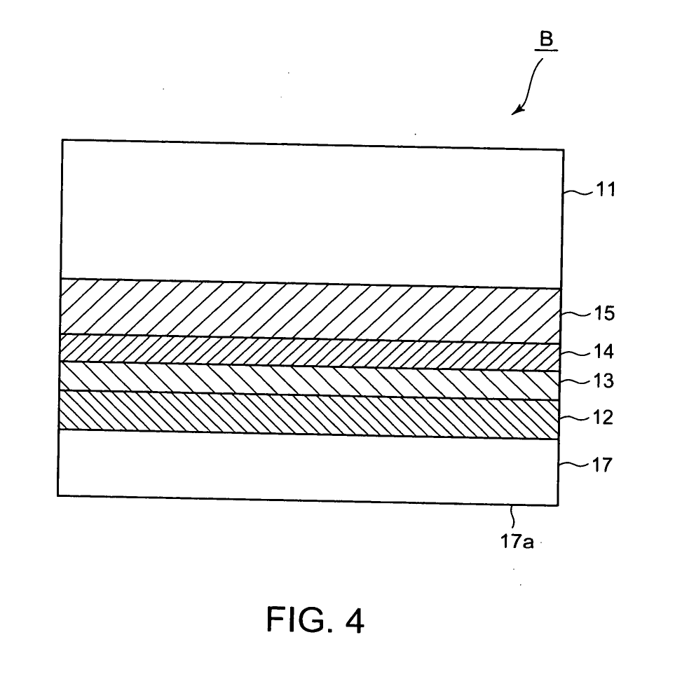

Moreover, the present invention is applicable to ultra-density phase-change optical storage media, such as, shown in FIG. 4.

An optical storage medium B shown in FIG. 4 has a structure in which a first protective layer 12, a recording layer 13, a second protective layer 14, a reflective layer 15 and a substrate 11 are stacked in order on a protective layer 17, with a thickness of about 0.1 mm, having a beam-incident surface 17a on the opposite side via which a laser beam is incident in recording, reproduction or erasure.

As discussed in detail, the present invention provides an optical recording storage medium that exhibits excellent recording characteristics in high-linear velocity recording (for example, at DVD×6 speed or higher) and excellent overwrite characteristics in initial or a plural number of overwriting, and also excellent long-term storagability.

What is claimed is:

1. A phase-change optical storage medium comprising a recording layer including an alloy of Ge—Sb—In—Sn, as a main component in materials that constitute the recording layer, composition ratios of Ge, Sb, In and Sn in the alloy satisfying ranges 0.08≦a≦0.20, 0.60≦b≦0.80, 0.05≦c≦0.20, and 0.01≦d≦0.15, where “a”, “b”, “c” and “dd” are the composition ratios of Ge, Sb, In and Sn, respectively, at a+b+c+d=1.

2. The phase-change optical storage medium according to claim 1, wherein a percentage of the alloy in the materials that constitute the recording layer is 50% or higher.

3. The phase-change optical storage medium according to claim 1 further comprising a reflective layer formed over the recording layer, the reflective layer including Ag, as a main component in materials that constitute the reflective layer.

4. The phase-change optical storage medium according to claim 3, wherein a percentage of Ag in the materials that constitute the reflective layer is 50% or higher.
